(19) United States
(12) Patent Application Publication
(10) Pub. No.: US 2025/0218198 A1
(43) Pub. Date: Jul. 3, 2025

(54) Information system and method for controlling an information system

(71) Applicant: Intel Corporation, Santa Clara, CA (US)

(72) Inventors: Cornelius BUERKLE, Karlsruhe (DE); Fabian OBORIL, Karlsruhe (DE); Kay-Ulrich SCHOLL, Malsch (DE)

(21) Appl. No.: 18/957,906

(22) Filed: Nov. 25, 2024

(30) Foreign Application Priority Data
Dec. 28, 2023 (DE) 10 2023 136 750.1

(51) Int. Cl. G06V 20/59; B60Q 9/00; G06V 20/40; G06V 40/18

(52) U.S. Cl. CPC G06V 20/597; B60Q 9/00; G06V 20/40; G06V 40/197

(57) ABSTRACT

An information system for a vehicle includes a processor configured to: determine system information representing one or more than one message relating to an occupant of the vehicle and/or the vehicle and/or an environment of the vehicle; determine a current driving task of the vehicle; determine, using sensor data representing a state of the driver of the vehicle, driver information representing a physical and/or mental state of the driver; determine, using the current driving task and the driver information, message presentation information indicating, for each of the one or more than one message, whether the message is to be presented to the driver and/or how the message is to be presented to the driver and/or at what time the message is to be presented to the driver; and generate control instructions to control at least one component of the vehicle according to the message presentation information.

### CROSS-REFERENCE TO RELATED APPLICATIONS

This non-provisional application claims prioriy to German patent application 10 2023 136 750.1, filed on Dec. 28, 2023, the entire contents of which are incorporated herein by reference.

### TECHNICAL AREA

Various aspects of this disclosure generally relate to an information system for a vehicle and a method for controlling the information system.

### BACKGROUND

Vehicles can include numerous devices (e.g., display and output devices such as a dashboard, a loudspeaker, a display of the presentation system (for example, an infotainment system), etc., but also input and control devices such as headlight switch, touchscreen display, gearshift, pedals, etc.), by means of which greatly varying information can be reported to the driver, such as warning messages, status messages, a report of an incoming call and/or an incoming message, recommendations of a driver assistance system, etc., and/or by means of which the driver can take influence, for example, on the driving behavior, the vehicle movement, and/or the interior comfort. However, driving situations and constellations can occur in and outside the vehicle in which these messages and/or the complexity of the vehicle control distract the driver and can thus result in hazardous situations. For example, when a driver is currently driving in reverse into a tight parking space (which requires a high level of concentration), a message appearing with an associated tone on the dashboard (for example, with respect to a defective brake light or ultrasonic distance measuring system) can result in a brief but critical distraction. This distraction can become a problem in particular for unexperienced and/or inattentive drivers or older people.

### BRIEF SPECIFICATION OF THE DISCLOSURE

According to various embodiments, an information system for a vehicle and a method for controlling the information system are provided, and/or an input or control system and a method for a vehicle are provided which reduce hazardous situations as a result of a distraction due to messages and/or less complex input or control requirements (for example, switching over to autonomous control if, for example, manually parking overwhelms the driver), in that each message and/or each input or control request is evaluated with respect to the present driving situation and a status of the driver. In this evaluation, it is decided whether a respective message and/or input or control request is important for the present driving task and whether the respective message and/or input or control request could result in distraction of the driver during the present driving task in consideration of the status of the driver, and it is then decided based on a result of the evaluation whether the respective message and/or input or control request is to be presented or offered to the driver and/or how the message and/or input or control request is to be presented or offered to the driver and/or at what time the message and/or input or control request is to be presented or offered to the driver.

### BRIEF SPECIFICATION OF THE FIGURES

In the drawings, reference signs in the various views generally refer to the same parts. The drawings are not necessarily to scale, instead in general focus is placed on illustrating the principles of the invention. In the following specification, various embodiments of the invention are described with reference to the following drawings, in which:

FIG. 1 shows a vehicle according to various aspects.

FIG. 2 shows various electronic components of the vehicle.

FIG. 3 shows an exemplary dashboard of a vehicle according to various aspects.

FIG. 4 shows exemplary presentation devices of a vehicle according to various aspects.

FIG. 5 shows a flow chart for controlling an information system of a vehicle according to various aspects.

FIG. 6 shows a status diagram of a status of a driver of a vehicle according to various aspects.

FIG. 7 shows a flow chart of a method for controlling an information system of a vehicle according to various aspects.

### DETAILED SPECIFICATION

The following detailed specification relates to the appended drawings which show specific details and embodiments for illustration, in which the invention can be embodied.

The word “exemplary” is used herein to mean “used as an example, case, or illustration”. Any embodiment described herein as “exemplary” is not necessarily to be considered preferred or advantageous in relation to other embodiments.

The terms “at least one” and “one or more” can be understood to mean that they include a numeric amount greater than or equal to one (e.g., one, two, three, four, [. . . ] etc.). The term “a plurality” can be understood to mean that it includes a numeric amount greater than or equal to two (e.g., two, three, four, five, [. . . ] etc.).

The terms “multiple” and “plurality” expressly refer to an amount greater than one. Accordingly, all expressions which expressly refer to the above-mentioned words (for example, a plurality of elements, multiple elements) refer to a set of elements, expressly to more than one of these elements. The expressions “group (of)”, “set (of)”, “collection (of)”, “series (of)”, “sequence (of)”, “grouping (of)” etc. and similar expressions in the specification and in the claims refer to an amount which is equal to or greater than one, thus one or more.

The expression “at least one of” with reference to a group of elements can be used here to mean at least one element from the group including the elements. For example, the expression “at least one of” in reference to a group of elements can be used here to mean a selection of: one of the listed elements, a plurality of one of the listed elements, a plurality of individual listed elements, or a plurality of a multiple of individual listed elements.

The term “data” used herein can be understood to mean that it includes information in any suitable analog or digital form, e.g., in the form of a file, a part of a file, a set of files, a signal or flow, a part of a signal or flow, a set of signals or flows, and the like. In addition, the term “data” can also be used for a reference to information, for example, in the form of a pointer. The term “data” is not restricted to the above-mentioned examples, however, and can assume various forms and represent any arbitrary information as understood in the technical world.

The term “processor” as used herein can be understood as any type of entity that permits the processing of data or signals. The data or signals can be handled, for example, according to at least one (i.e. one or more than one) specific function executed by the processor. A processor can include or be formed from an analog circuit, a digital circuit, a mixed-signal circuit, a logic circuit, a microprocessor, a central processing unit (CPU), a graphics processing unit (GPU), a digital signal processor (DSP), a field-programmable gate arrangement (FPGA), an integrated circuit, or any combination thereof. Any other type of the implementation of the respective functions which are described in more detail hereinafter can also be understood as a processor or logic circuit. It is apparent that one or more of the method steps described herein in detail can be executed (for example, implemented) by a processor by one or more specific functions executed by the processor. The processor can therefore be configured to carry out one of the methods described herein or its components for information processing.

Differences between software-implemented and hardware-implemented data processing can blur. A processor, a security system, a computing system, and/or other aspects described herein can be implemented in software, hardware, and/or as a hybrid implementation with both software and hardware.

The term “memory” is understood here as a computer-readable medium in which data or information can be stored for retrieval. A memory used in the embodiments can be a volatile memory, such as a DRAM (dynamic random access memory), or a nonvolatile memory, such as a PROM (programmable read-only memory), an EPROM (erasable PROM), an EEPROM (electrically erasable PROM), or a flash memory, such as a floating-gate memory device, a charge-absorbing memory device, a MRAM (magnetoresistive random access memory), or a PCRAM (phase-change random access memory). A memory can be a flash memory, a solid-state memory, a magnetic tape, a hard drive, an optical drive, etc. or any combination thereof. Registers, shift registers, processor registers, data buffers, etc. also fall under the concept of “memory”. The term “software” relates to all types of executable commands, including firmware.

The term “system” (e.g., a computing system, an information system, a security system, etc.), which will be discussed in more detail here, can be understood as a set of interacting elements, wherein the elements can be, by way of example and not restrictively, one or more mechanical components, one or more electrical components, one or more instructions (for example, coded in storage media), and/or one or more processors and the like.

If not expressly indicated otherwise, the term “transmit” includes both direct (point-to-point) and also indirect transmission (via one or more intermediate points). In a similar manner, the term “receive” includes both direct and indirect reception. In addition, the terms “transmit”, “receive”, “communicate”, and similar terms include both physical transmission (for example, the transmission of radio signals) and logical transmission (for example, the transmission of digital data via a logic connection on the software level). For example, a processor or a control device can transmit or receive data via a connection on the software level to another processor or another control unit in the form of radio signals, wherein the physical transmission and the reception are handled by components of the radio layer such as HF transceivers and antennas and the logical transmission and the reception are carried out via the connection on the software level by the processors or control devices. The term “communicate” includes both transmitting and receiving, i.e. unidirectional or bidirectional communication in one or both directions, i.e. incoming and outgoing.

The term “calculate” includes both “direct” calculations by means of a mathematical expression/a formula/a relationship and “indirect” calculations by means of lookup tables or hash tables and other array indexing or search operations.

A “vehicle” can be understood as any type of driven or drivable object. A vehicle can be, for example, a driven object having an internal combustion engine, a reaction motor, an electrically driven object, a hybrid driven object, or a combination thereof. A vehicle can be or include an automobile, a bus, a minibus, a delivery vehicle, a truck, a caravan, a vehicle trailer, a motorcycle, a bicycle, a three-wheeled vehicle, a train locomotive, a train car, a driving robot, a personnel transporter, a boat, a ship, a submersible, a submarine, a drone, an aircraft, a rocket, and the like.

According to various aspects, the vehicle can be a vehicle that travels on the ground. A “vehicle that travels on the ground” (also referred to as a ground vehicle) can be understood as any type of vehicle as described above configured so that it is moved or driven on the ground, e.g., on a road, a path, a track, one or more rails, off-road, etc. An “aircraft” can be understood as any type of vehicle as described above capable of maneuvering for an arbitrary time span above the ground, such as a drone. Similarly as a ground vehicle is equipped with wheels, belts, etc. in order to move across the ground, an “aircraft” can have one or more propellers, wings, fans, etc. to be able to maneuver in the air. A “water vehicle” can be understood as any type of vehicle which, as described above, can be maneuvered on or below the liquid surface, such as a boat on the water surface or a submarine under the water surface. It is clear that some vehicles can be configured so that they can be operated as a ground vehicle, aircraft, and/or water vehicle.

The term “at least partially automated vehicle” can specify a vehicle capable of performing at least one navigation change without driver input. A navigation change can specify or include a change of the steering, the brakes, or the acceleration/deceleration of the vehicle. A vehicle can be referred to as autonomous if it is fully automatic (for example, fully functional without driver input). Partially automated vehicles can include vehicles which can be operated during certain periods of time under the supervision of the driver and during other periods of time without supervision of the driver. At least partially automated vehicles can also include vehicles which only control some aspects of the vehicle navigation, such as the steering (for example, to maintain a vehicle course between the lane boundaries) or some steering operations under certain circumstances (but not under all circumstances), but leaves other aspects of the vehicle navigation to the driver (such as braking or braking under certain circumstances). At least partially automated vehicles can also be vehicles which share the supervision over one or more aspects of the vehicle navigation (for example, “hands-on”, i.e. as a reaction to a driver input), and vehicles that supervise one or more aspects of the vehicle navigation under certain circumstances (for example, “hands off”, i.e. independently of the driver input). At least partially automated vehicles can also include vehicles that control one or more aspects of the vehicle navigation under certain circumstances, for example, under certain environmental conditions (for example, spatial areas, roadway conditions). In various aspects, at least partially automated vehicles can take over some or all aspects of the braking, the speed control, and/or the steering of the vehicle. Autonomous vehicles can also include those which can drive without a driver. The degree of automation of a vehicle can be described or defined by the degree of automation of the Society of Automotive Engineers (SAE) (for example, according to the definition of the SAE, for example, in SAE J3016 2018: Taxonomy and definitions for terms related to driving automation systems for on road motor vehicles) or of other relevant professional organizations. The SAE level can have a value extending from a minimum level, such as level 0 (for illustration: essentially no driving automation) to a highest level, such as level 5 (for illustration: complete driving automation). An at least partially automated vehicle can therefore be an automated vehicle or an autonomous vehicle. For example, the at least partially automated vehicle can be a semiautomated vehicle (according to level 2), a highly automated vehicle (according to level 3), a fully automated vehicle (according to level 4), or an autonomous vehicle (according to level 5).

Various aspects described herein relate to a vehicle controlled by a driver at least in some situations. The vehicle described herein can therefore be a vehicle according to one of levels 0 to 4.

A model (for example, a model based on machine learning (also referred to as a machine learning model)) can include or be, for example, a reinforcement learning model (e.g., using Q learning, temporal difference (TD), deep adversarial networks, etc.) and/or a classification model (e.g., a linear classifier (for example, a logistical regression classifier or a naïve Bayes classifier), a support vector machine, a decision tree, a boosted tree classifier, a random forest classifier, a neural network, or a nearest neighbor model). A neural network can be or include any type of neural network, for example, a convolutional neural network (CNN), a variational autoencoder network (VAE), a sparse autoencoder network (SAE), a recurrent neural network (RNN), a deconvolutional neural network (DNN), a generative adversarial network (GAN), a forward-thinking neural network, a sum-product neural network, a transformer-based network, etc.

The term “image” as used herein can be any type of digital image data which can represent a visual representation, such as a digital RGB image, a digital RGB-D image, a binary image, a 3D image, a point cloud, a time series, a semantic segmentation image, etc.

A probability described herein comprises an associated probability value. If a probability is compared herein to another probability or threshold value (for example, greater than, for example, less than, for example, higher, for example, lower, for example, above), this relates to the probability value associated with the probability.

The expression that an element, a parameter, etc. “represents” another element, another parameter, etc. can be understood to mean that they are linked with one another, for example, the element and/or the parameter is one (for example, unique, for example, one to one) function of the other element and/or parameter.

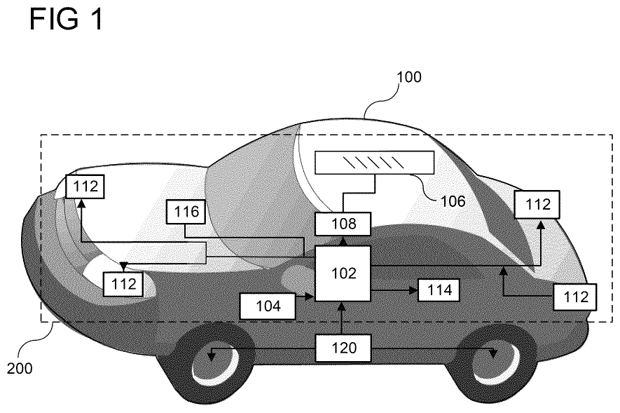

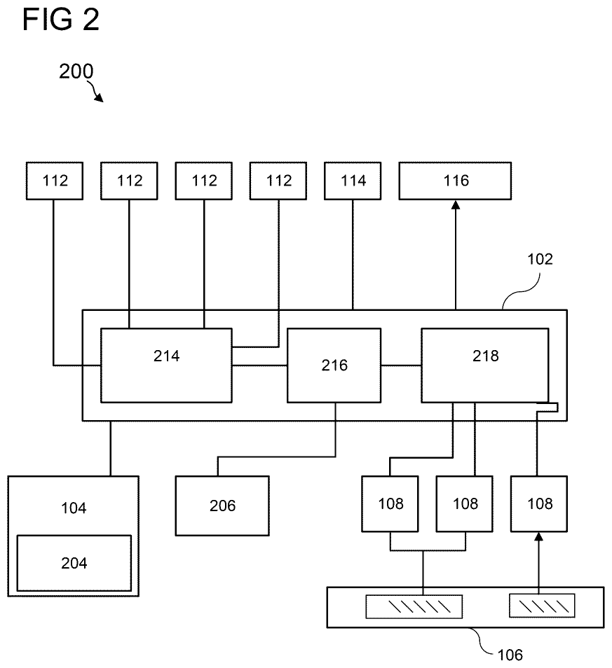

FIG. 1 shows a vehicle 100 having a mobility system 120 and a control system 200 (see also FIG. 2) according to various aspects. It is understood that the vehicle 100 and the control system 200 are exemplary and can therefore be simplified for purposes of explanation. While the vehicle 100 is represented, for example, as a ground vehicle, aspects of this disclosure can be applied similarly or analogously to aircraft, such as drones, or water vehicles, such as boats. In addition, the quantities and positions of the elements as well as the relative distances (as described above, the figures are not to scale) are shown as examples and are not restricted thereto. The components of the vehicle 100 can be arranged around a vehicle housing of the vehicle 100, installed on or outside the vehicle housing, enclosed in the vehicle housing, or in another arrangement relative to the vehicle housing in which the components move with the driving vehicle 100. The vehicle housing can be, for example, a car body, a drone body, an aircraft or helicopter fuselage, a boat hull, or a similar type of vehicle body depending on which type of vehicle the vehicle 100 is.

In some aspects, the control system 200 can include or be a safety system.

In addition to a control system 200, the vehicle 100 can also include a mobility system 120. The mobility system 120 can include components of the vehicle 100 related to the steering and movement of the vehicle 100. In some cases, in which the vehicle 100 is an automobile, the mobility system 120 can include, for example, wheels and axles, a suspension, a motor, a transmission, brakes, steering wheel, associated electrical circuits and cables, and all other components used in the drive of an automobile. In some cases, in which the vehicle 100 is an aircraft, the mobility system 120 can include one or more rotors, propellers, jet engines, wings, rotors or tail flaps, air brakes, a yoke or a cycle, the associated electrical circuits and wiring, and all other components used in the flight of an aircraft. In some cases, in which the vehicle 100 is a water vehicle or an underwater vehicle, the mobility system 120 can include one or more of the following elements: rudders, motors, propellers, a steering wheel, associated electrical circuits and wiring, and all other components used for the control or movement of a water vehicle. In various aspects, the mobility system 120 can also include an autonomous driving functionality and accordingly can include an interface with one or more processors 102 configured to perform calculations and decisions for autonomous driving, and an array of sensors for detecting movement and obstacles. In this meaning, the mobility system 120 can be supplied with instructions for controlling the navigation and/or mobility of the vehicle 100 by one or more components of the control system 200. The components for at least partially automated driving of the mobility system 120 can also be connected to one or more radiofrequency transceivers (RF) 108, in order to facilitate the coordination of the mobility with other vehicle communication devices located in the vicinity and/or central network components, which perform decisions and/or calculations in connection with the autonomous driving.

The control system 200 can include a specific implementation of various components depending on the requirements. As shown in FIG. 1 and FIG. 2, the control system 200 can include one or more processors 102, one or more memory devices (abbreviated: memories) 104, an antenna system 106, which can include one or more antenna groups at various points of the vehicle for radio frequency coverage, one or more radio frequency transceivers 108, one or more data acquisition devices 112, one or more position devices 114, which can include components and circuits for receiving and determining a position on the basis of a global navigation satellite system (GNSS) and/or a global positioning system (GPS), and one or more measuring sensors 116, e.g., speedometer, altimeter, gyroscope, speed sensors, etc.

The control system 200 can be configured to control the mobility of the vehicle 100 via the mobility system 120 and/or the interaction with its surroundings, for example, the communication with other devices or network infrastructure elements (NIEs) such as base stations, via the data acquisition devices 112 and the radio frequency communication arrangement, including the one or more HF transceivers 108 and the antenna system 106.

The one or more processors 102 can include a data acquisition processor 214, an application processor 216, a communication processor 218, and/or any other suitable processing device. Each processor 214, 216, 218 of the one or more processors 102 can include various types of hardware-based processing devices. For example, each processor 214, 216, 218 can include a microprocessor, preprocessors (such as an image preprocessor), graphics processors, a central processing unit (CPU), assistance circuits, digital signal processors, integrated circuits, memories, or other types of devices which are capable of executing applications and for image processing and analysis. In various aspects, each processor 214, 216, 218 can include any type of single-core or multicore processor, microcontroller for mobile devices, central processing unit, etc. These processor types can each include multiple processing units having local memory and command sets. Such processors can include video inputs for receiving image data from multiple image sensors and also video output functions.

Each of the processors 214, 216, 218 can be configured to execute certain functions according to program instructions, which can be stored in a memory of the one or more memories 104. In other words, a memory of the one or more memories 104 can store software which, when it is executed by a processor (for example, by the one or more processors 102), controls operation of the system, such as a driving and/or safety system. A memory of the one or more memories 104 can store one or more databases and image processing software as well as a trained system, such as a neural network or a deep neural network. The one or more memories 104 can include an arbitrary number of random access memories, read-only memories, flash memories, hard drives, optical memories, tape memories, removable memories, and other types of memories. Alternatively, each of the processors 214, 216, 218 can include an internal memory for such storage.

The data acquisition processor 216 can include a processing circuit, such as a CPU, for processing the data acquired by the data acquisition devices 112. If the one or more data acquisition devices are, for example, image acquisition units, such as one or more cameras, the data acquisition processor can then include image processors for processing image data that use the information obtained by the image acquisition units as the input. The data acquisition processor 216 can be configured to create voxel maps, which represent the surroundings of the vehicle 100 in detail, on the basis of the data input by the data acquisition devices 112, for example, by the cameras.

The application processor 216 can be a CPU and can be configured to process the layers above the protocol stack, including the transport and application layers. The application processor 216 can be configured to execute various applications and/or programs of the vehicle 100 on an application layer of the vehicle 100, such as an operating system (OS), a user interface (UI) 206 for assisting the user interaction with the vehicle 100, and/or various user applications. The application processor 216 can form an interface with the communication processor 218 and function as a source in the transmission path) and sink (in the reception path) for user data such as speech data, audio/video/image data, message data, application data, fundamental Internet/web access data, etc. In the transmission path, the communication processor 218 can therefore receive and process outgoing data provided by the application processor 216 in accordance with the layer-specific functions of the protocol stack and provide the resulting data to the digital signal processor 208. The communication processor 218 can then process the received data on the physical layer, in order to generate digital baseband sampling values, which the digital signal processor can pass on to the HF transceiver(s) 108. The HF transceiver(s) 108 can then process the digital baseband sampling values in order to convert the digital baseband sampling values into analog HF signals, which the HF transceiver(s) 108 can transmit wirelessly via the antenna system 106. In the reception path, the HF transceiver(s) 108 can receive analog HF signals from the antenna system 106 and can process the analog HF signals to obtain digital baseband sampling values. RF transceivers 108 can pass on the digital baseband sampling values to the communication processor 218, which processes the digital baseband sampling values on the physical layer. The communication processor 218 can then forward the resulting data to other processors of the one or more processors 102, which process the resulting data according to the layer-specific functions of the protocol stack and can forward the resulting incoming data to the application processor 216. The application processor 216 can then process the incoming data on the application layer, which can include the execution of one or more application programs using the data and/or the presentation of the data for a user via one or more user interfaces 206. The user interfaces 206 can include one or more display screens, microphones, mice, touchpads, keyboards, or any other interface offering a mechanism for user inputs.

The communication processor 218 can include a digital signal processor and/or a control device, which can control a communication functionality of the vehicle 100 according to the communication protocols and which are connected to one or more radio access networks and which can execute the control of the antenna system 106 and of the HF transceiver(s) 108 in order to transmit and receive radio signals according to the formatting and time planning parameters, which are defined by each communication protocol. Although various practical embodiments can include separate communication components for each supported radio communication technology (e.g., a separate antenna, an RF transceiver, a digital signal processor, and a control device), the configuration of the vehicle 100 shown in FIGS. 1 and 2 can only represent one component for reasons of clarity. The configuration of the vehicle 100 shown in FIGS. 1 and 2 only represents a single example of such components.

The vehicle 100 can transmit and receive wireless signals using the antenna system 106, which can be a single antenna or an antenna group having multiple antenna elements. In various aspects, the antenna system 202 can include additional analog antenna combinations and/or beamforming circuits. In the reception path (RX), the HF transceiver(s) 108 can receive analog high-frequency signals from the antenna system 106 and perform analog and digital HF front end processing of the analog high-frequency signals to generate digital baseband sampling values (for example, in-phase/quadrature (IQ) sampling values), which are provided to the communication processor 218. RF transceiver(s) 108 can include analog and digital reception components, including amplifiers (for example, low-noise amplifiers (LNAs)), filters, RF demodulators (for example, RF-IQ demodulators), and analog-to-digital converters (ADCs), which can use RF transceivers 108 for converting the received high-frequency signals into digital baseband sampling values. In the transmission (TX) path, the HF transceiver(s) 108 can receive digital baseband sampling values from the communication processor 218 and perform analog and digital HF front end processing on the digital baseband sampling values in order to generate analog high-frequency signals, which are provided to the antenna system 106 for wireless transmission. RF transceivers 108 can therefore include analog and digital transmission components, including amplifiers (for example, power amplifiers (PAs), filters, RF modulators (for example, RF-IQ modulators), and digital to analog converters (DACs), which can use RF transceivers 108 to mix the digital baseband sampling values received from the communication processor 218 and generate the analog high-frequency signals for the wireless transmission by the antenna system 106. In various aspects, the communication processor 218 can control the radio transmission and the reception of the HF transceiver(s) 108, including defining the transmission and reception radio frequencies for the operation of the HF transceiver(s) 108.

According to various aspects, the communication processor 218 can include a baseband modem configured to perform transmission and reception processing of the physical layer (PHY, layer 1), in order to prepare outgoing transmission data in the transmission path, which are provided by the communication processor 218, for transmission via the RF transceiver(s) 108, and to prepare received data incoming in the reception path, which are provided by the RF transceiver(s) 108, for processing by the communication processor 218. The baseband modem can include a digital signal processor and/or a controller. The digital signal processor can be configured to perform one or more of the following functions: error recognition, forward error correction encoding/decoding, channel encoding and nesting, channel modulation/demodulation, physical channel assignment, radio measurement and search, frequency and time synchronization, antenna diversity processing, power control and weighting, rate matching, forwarding processing, interference suppression, and other processing functions of the physical layer. The digital signal processor can be structurally implemented as hardware components (for example, as one or more digitally configured hardware circuits or FPGAs), as software-defined components (for example, one or more processors configured to execute program code that defines arithmetic, control, and I/O commands (for example, software and/or firmware), which are stored in a non-transitory computer-readable memory medium), or as a combination of hardware and software components. In various aspects, the digital signal processor can include one or more processors configured to call and execute program code that defines control and processing logic for processing operations of the physical layer. In various aspects, the digital signal processor can execute processing functions using software via the execution of executable instructions. In various aspects, the digital signal processor can include one or more dedicated hardware circuits (e.g., ASICs, FPGAs, and other hardware) digitally configured to execute specific processing functions, wherein the one or more processors of the digital signal processor can outsource certain processing tasks to these dedicated hardware circuits, which are known as hardware accelerators. Exemplary hardware accelerators can be Fast Fourier Transform circuits (FFT) and encoder/decoder circuits. In various aspects, the processor and hardware acceleration components of the digital signal processor can be implemented as a coupled integrated circuit.

The vehicle 100 can be configured for operation with one or more radio communication technologies. The digital signal processor of the communication processor 218 can be responsible for the processing functions of the lower layer (for example, layer 1/PHY) of the radio communication technologies, while a controller of the communication processor 218 can be responsible for the protocol stack functions of the upper layer (for example, data connection layer/layer 2 and/or network layer/layer 3). The control device can therefore be responsible for the control of the radio communication components of the vehicle 100 (antenna system 106, RF transceiver(s) 108, position device 114, etc.) in correspondence with the communication protocols of each assisting radio communication technology and can accordingly represent the access stratum and non-access stratum (NAS) (which also includes layer 2 and layer 3) of each assisting radio communication technology. The control device can be structurally embodied as a protocol processor configured so that it executes protocol stack software (which is retrieved from a memory of the control device) and then controls the radio communication components of the vehicle 100 so that they transmit and receive communication signals in correspondence with the corresponding protocol stack control logic defined in the protocol stack software. The control device can include one or more processors configured so that they call and execute program code which defines the protocol stack logic of the upper layer for one or more radio communication technologies, which can include functions of the data connection layer/layer 2 and the network layer/layer 3. The control device can be configured to execute both functions of the user level and the control level in order to facilitate the transmission of data of the application layer to and from the vehicle 100 according to the specific protocols of the assisting radio communication technology. The functions of the user level can include header compression and encapsulation, security, error checking and correction, channel multiplexing, time planning, and priority, while the functions of the control level can include the configuration and maintenance of radio carriers. The program code called and executed by the controller of the communication processor 218 can include executable instructions that define the logic of such functions.

In various aspects, the vehicle 100 can be configured to transmit and receive data according to multiple radio communication technologies. Accordingly, in various aspects, one or more antenna system(s) 106, RF transceiver(s) 108, and communication processors 218 can include separate components or instances dedicated to various radio communication technologies and/or uniform components that can be used jointly by various radio communication technologies. For example, in various aspects, multiple controllers of the communication processor 218 can be configured so that they execute multiple protocol stacks, each of which is dedicated to a different radio communication technology and which are located either on the same processor or on various processors. In various aspects, multiple digital signal processors of the communication processor 218 can include separate processors and/or hardware accelerators which are each associated with different radio communication technologies, and/or one or more processors and/or hardware accelerators which are used jointly by multiple radio communication technologies. In various aspects, the HF transceiver(s) 108 can include separate HF circuit sections which are associated with various respective radio communication technologies, and/or HF circuit sections which are used jointly by multiple radio communication technologies. In some cases, the antenna system 106 can include separate antennas which are each associated with different radio communication technologies, and/or antennas which are used jointly by multiple radio communication technologies. Accordingly, the antenna system 106, the HF transceiver(s) 108, and the communication processor 218 can include separately and/or jointly used components intended for multiple radio communication technologies.

The communication processor 218 can be configured so that it implements one or more vehicle-to-all (V2X) communication protocols, which can include vehicle-to-vehicle (V2V), vehicle-to-infrastructure (V2I), vehicle-to-network (V2N), vehicle-to-pedestrian (V2P), vehicle-to-device (V2D), vehicle-to-grid (V2G), and other protocols. The communication processor 218 can be configured to transmit communications, such as communications (one-sided or two-sided) between the vehicle 100 and one or more other (target) vehicles in the surroundings of the vehicle 100 (for example, to facilitate the coordination of the navigation of the vehicle 100 with regard to or together with other (target) vehicles in the surroundings of the vehicle 100), or even a broadcast transmission to non-specified receivers in the vicinity of the transmitting vehicle 100.

The communication processor 218 can be configured to operate according to various desired radio communication protocols or standards via a first HF transceiver of the one or more HF transceiver(s) 108. For example, the communication processor 218 can be configured according to a short-range mobile wireless communication standard such as Bluetooth, Zigbee, and the like and the first HF transceiver can correspond to the corresponding short-range mobile wireless communication standard. As a further example, the communication processor 218 can be configured to operate according to a moderate-range or long-range mobile wireless communication standard via a second HF transceiver of the one or more HF transceiver(s) 108, such as a 3G (for example, Universal Mobile Telecommunications System—UMTS), a 4G (for example, Long-Term Evolution-LTE), or a 5G mobile wireless communication standard in accordance with the corresponding 3GPP (Third Generation Partnership Project) standard. As a further example, the communication processor 218 can be configured to operate via a third HF transceiver of the one or more HF transceiver(s) 108 according to a Wireless Local Area Network communication protocol or standard, for example, according to IEEE 802.11 (e.g. 802.11, 802.11a, 802.11b, 802.11g, 802.11n, 802.11p, 802.11-12, 802.11ac, 802.11ad, 802.11ah, and the like). The RF transceiver(s) 108 can be configured to transmit signals via the antenna system 106 via an air interface. The RF transceivers 108 can each have a corresponding antenna element of the antenna system 106 or can share an antenna element of the antenna system 106.

The memory 214 can be a memory component of the vehicle 100, such as a hard drive or another permanent memory device. Although it is not explicitly shown in FIGS. 1 and 2, the various other components of the vehicle 100, for example, one or more processors 102, can additionally each include integrated permanent and nonpermanent memory components, for example, for storing software program code, buffering data, etc.

The antenna system 106 can include a single antenna or multiple antennas. In various aspects, each of the one or more antennas of the antenna system 106 can be placed at multiple points of the vehicle 100 in order to ensure maximum HF coverage. The antennas can include a phase-controlled antenna group, a switch beam antenna group having multiple antenna elements, etc. The antenna system 106 can be configured to operate according to analog and/or digital beamforming schemes in order to maximize the signal amplification and/or ensure a high degree of information protection. The antenna system 106 can include separate antennas, which are each dedicated to different radio communication technologies, and/or antennas which are used jointly by multiple radio communication technologies. Although it is shown as a single element in FIG. 1, the antenna system 106 can include a plurality of antenna elements (such as antenna groups) positioned at various points of the vehicle 100. The placement of the multiple antenna elements can be strategically selected to ensure a desired degree of the HF coverage. Additional antennas can thus be attached, for example, on the front side, the rear side, the corners, and/or the sides of the vehicle 100.

The data acquisition devices 112 can include an arbitrary number of data acquisition devices and components depending on the requirements of a specific application. These can include: image acquisition devices, proximity detectors, acoustic sensors, infrared sensors, piezoelectric sensors, etc. which supply data about the vehicle surroundings. Image acquisition devices can be cameras (e.g., standard cameras, digital cameras, video cameras, SLR cameras, infrared cameras, stereo cameras, etc.), charge-coupled devices (CCDs), or any type of image sensor. The proximity detectors include radar sensors, lidar sensors (light detection and ranging), millimeter wave radar sensors, etc. Acoustic sensors can be: microphones, sonar sensors, ultrasonic sensors, etc. Accordingly, each of the data acquisition devices can be configured to acquire a certain type of data from the surroundings of the vehicle 100 and pass on the data to the data acquisition processor 214 in order to supply an accurate image of the surroundings of the vehicle to the vehicle. The data acquisition devices 112 can be configured to implement preprocessed sensor data, such as radar target lists or lidar target lists, in conjunction with the acquired data.

The measuring devices 116 can also include other devices for measuring vehicle state parameters, such as a speed sensor (for example, a speedometer) for measuring the speed of the vehicle 100, one or more acceleration sensors (either single-access or multi-axis) for measuring the accelerations of the vehicle 100 along one or more axes, a gyroscope for measuring the orientation and/or the angular velocity, odometers, altimeters, thermometers, etc. It is understood that the vehicle 100 can have different measuring devices 116 depending on the type of the vehicle, e.g., automobile, drone, or boat.

Position devices 114 can include components for determining the position of the vehicle 100. These can include, for example, circuits for a global positioning system (GPS) or another global satellite navigation system (GNSS), which are configured so that they receive signals from a satellite system and determine a position of the vehicle 100. The position devices 114 can accordingly equip the vehicle 100 with satellite navigation functions.

The one or more memories 104 can store data, for example, in a database or in another format which can correspond to a map. The map can indicate, for example, the location of known orientation points, roads, paths, network infrastructure elements, or other elements of the surroundings of the vehicle 100. The one or more processors 102 can process sensory information (e.g., images, radar signals, depth information from lidar, or stereo processing of two or more images) of the surroundings of the vehicle 100 together with position information, e.g., a GPS coordinate, an ego movement of the vehicle, etc., to determine a current position of the vehicle 100 relative to the known landmarks and refine the determination of the vehicle position. Certain aspects of this technology can be included in a localization technology such as a mapping and routing model.

The map database (DB) 204 can include any type of database in which (digital) map data for the vehicle 100, for example, for the control system 200, are stored. The map database 204 can include data relating to the position of various objects in a reference coordinate system, e.g., roads, water features, geographic features, companies, tourist attractions, restaurants, filling stations, etc. Not only can the positions of such objects be stored in the map database 204, but also descriptors relating to these objects, for example, names which are connected to one of the stored features. In various aspects, a processor of the one or more processors 102 can download information from the map database 204 via a wired or wireless data connection to a communication network (for example, via a cellular network and/or the Internet, etc.). In some cases, the map database 204 can store a sparse data model having polynomial representations of specific road features (for example, roadway markings) or target trajectories for the vehicle 100. The map database 204 can also include stored representations of various recognized landmarks, which can be provided for determining or updating a known position of the vehicle 100 in relation to a target trajectory. The representations of the orientation points can include data fields such as the type of the orientation point, the location of the orientation point, and other possible identifiers.

In addition, the control system 200 can include a driving model, which is implemented, for example, in an advanced driver assistance system (ADAS) and/or a driver assistance and (at least partially) automated or autonomous driving system. For example, the control system 200 can include (for example, as part of the driving model) a computer implementation of a formal model such as a safe driving model. A safe driving model can be or include a mathematical model that formalizes an interpretation of the applicable laws, norms, guidelines, etc. which are applicable to self-driving vehicles. A model for safe driving can be conceived so as to achieve, for example, three goals: First, the interpretation of the law can be founded in the meaning that it corresponds to the human interpretation of the law; second, the interpretation should result in reasonable driving politics, i.e., agile driving politics and not an excessively defensive manner of driving, which would inevitably annoy other human drivers and block the traffic, which would in turn restrict the scalability of the system use; and third the interpretation should be checkable efficiently, i.e., it should be able to be strictly substantiated that the self-driving (autonomous) vehicle correctly implements the interpretation of the law. A model for safe driving can be or include, for example, a mathematical model for ensuring safety, which enables hazardous situations to be identified and suitable reactions thereto to be performed, so that accidents at which the driver is at fault can be avoided.

As described above, the vehicle 100 can include the control system 200, as also described below with reference to FIG. 2. The vehicle 100 can include one or more processors 102 integrated in an engine control unit (ECU) or separate therefrom, that the mobility system 120 of the vehicle 100 can include. The control system 200 can in general generate data for controlling or assisting the control of the ECU and/or other components of the vehicle 100 in order to control the movement of the vehicle 100 via the mobility system 120 directly or indirectly. The one or more processors 102 of the vehicle 100 can be configured to implement the aspects and methods described herein.

The components shown in FIG. 1 and FIG. 2 can be connected to one another via any suitable interfaces. In addition, not all connections between the components are explicitly shown, and other interfaces between components can be present in the scope of this disclosure.

According to various aspects, the vehicle 100 can include an information system and/or an input or control system. Both the information system and/or the input or control system can in certain situations result in distraction of the driver (e.g., also depending on the physical and mental state of the driver, a distraction of the driver, the complexity of the systems and user interfaces, the traffic volume, the course of the road, the surroundings, etc.). Various aspects are specified hereinafter as examples of the information system. It is understood that the exemplary specification for the information system applies accordingly to the input system and/or control system.

The information system can include, for example, at least one processor of the one or more processors 102. In some aspects, the information system can include the control device.

The vehicle 100 can include at least one component by means of which messages can be presented to the driver. A presentation of a message described herein can be a visual and/or auditory presentation of the message. Illustratively, the driver can be informed with respect to the method via image and/or tone. Therefore, the at least one component can include, for example, one (or more than one) loudspeaker for the auditory presentation of the message to the driver. The at least one component can include, for example, one (or more than one) display unit for the visual presentation of the message to the driver. In some aspects, the information system can include the at least one component of the vehicle 100.

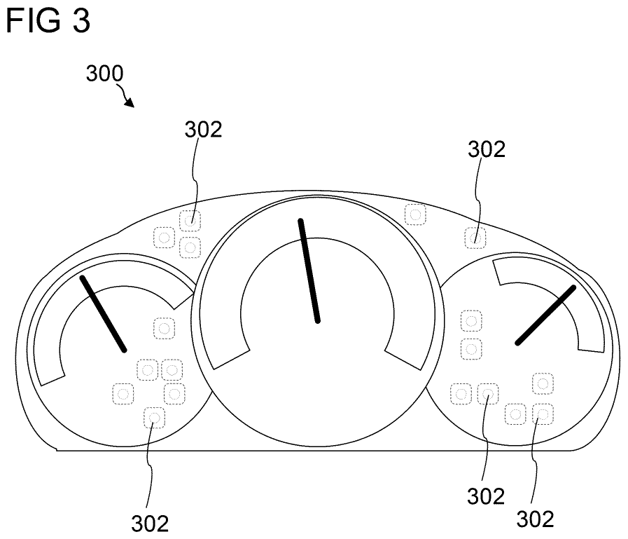

FIG. 3 shows an exemplary dashboard 300 of the vehicle 100 according to various aspects. The dashboard 300 can comprise a display unit for displaying messages 302.

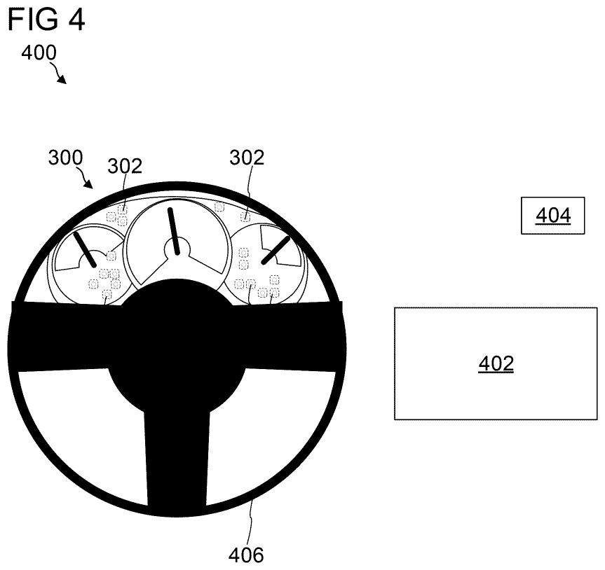

FIG. 4 shows exemplary presentation devices 400 of the vehicle 100 according to various aspects. For example, the driver can include another display unit 402 in addition to the dashboard 300. The other display unit 402 can be, for example, a display unit of a presentation system (such as an infotainment system). Furthermore, the vehicle 100 can include one or more than one loudspeaker 404 for auditory presentation of messages. The auditory presentation of a message can be performed in addition to the visual presentation (for example, to amplify or highlight the message), and can be, for example, a tone, a noise, or a voice. It is understood that these are exemplary presentation devices 400 and that the vehicle 100 can additionally or alternatively include any other type of presentation device capable of communicating a message (for example, in an auditory and/or visual manner) to the driver.

A “message” described herein can be any type of information that is or should be reported to the driver. A message can be, for example, a warning message that represents a warning with respect to the driver (for example, detected fatigue) and/or the surroundings of the vehicle 100 (for example, slippery road) and/or the vehicle 100 (for example, check engine light). A message can be, for example, a status message reporting a status of the vehicle 100 (for example, service in 1000 km). A message can be, for example, an event message (for example, an incoming call and/or an incoming message to the driver), which represents an event. A message can be, for example, a notification message which represents a notification to the driver (for example, a recommendation of a driver assistance system, acoustic feedback of a parking aid, etc.). It is to be understood that the above-described messages are exemplary and that a message specified herein can also be any other type of message which is to be reported to the driver (or another occupant). It is also understood that a message specified herein to the driver can also be a message to a passenger of the vehicle 100, as long as the presentation of the message could distract the driver of the vehicle 100. For example, a user device (e.g., a smart phone, a tablet, etc.) of a front passenger of the vehicle can be connected to the presentation system (for example, by means of Bluetooth). In this case, the message can be, for example, an incoming call and/or an incoming message to the front passenger as an event message. The message can therefore be, for example, a message with respect to an occupant (for example, driver, front passenger, passenger, etc.) of the vehicle 100.

Various aspects with respect to messages are specified by way of example herein. It is to be understood that the exemplary specification for messages applies accordingly to one or more than one input or control request. Illustratively, an input or control request can also be understood as a message herein.

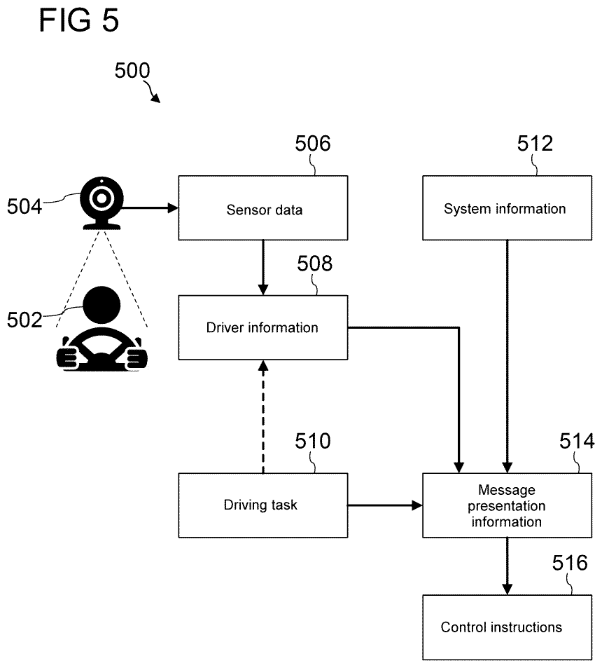

FIG. 5 shows a flow chart 500 for controlling the information system of the vehicle 100 according to various aspects.

The vehicle 100 (for example, the information system) can include one or more than one sensor 504 configured to acquire sensor data 506 representing a (current) state of the driver 502 of the vehicle 100. For example, the one or more than one sensor 504 can include an imaging unit (for example, a camera) directed toward the driver 502. In this case, the sensor data can include image data representing an image of the driver 502. For example, the one or more than one sensor 504 can include a microphone configured to acquire audio data representing noises generated by the driver (and therefore auditory information with respect to the state of the driver). For example, the one or more than one sensor 504 can include a heart rate sensor (for example, in the steering wheel 406) configured to acquire heart rate data representing a heart rate of the driver. According to various aspects, the vehicle can include a driver monitoring system which includes the one or more than one sensor 504. The driver monitoring system can be configured to provide the sensor data 506 to the information system.

The at least one processor of the information system can be configured to determine driver information 508 using the sensor data 506. The driver information 508 can represent a (current) attentiveness and/or a tension of the driver. In some aspects, the driver monitoring system can be configured to determine the physical and/or mental state of the driver (for example, the attentiveness (for example, represented by an attentiveness value) and/or the tension (for example, represented by a tension value)) and provide it to the information system.

The attentiveness of the driver specified herein can be an attentiveness of the driver with respect to the driving task. The attentiveness of the driver can indicate, for example, whether or not the driver notices objects in the surroundings of the vehicle. If the driver is not looking at the road, for example, they are inattentive. The attentiveness of the driver specified herein can be indicated by an attentiveness value representing the attentiveness (for example, by an attentiveness value between 0 for inattentive and 1 for attentive, or vice versa).

The attention of the driver specified herein can indicate, for example, whether the driver is presently nervous and/or requires a high degree of concentration in the present driving task. If the driver has an elevated heart rate, for example, they are tense. The tension of the driver specified herein can be indicated by a tension value representing the tension (for example, by a tension value between 0 for relaxed and 1 for tense, or vice versa).

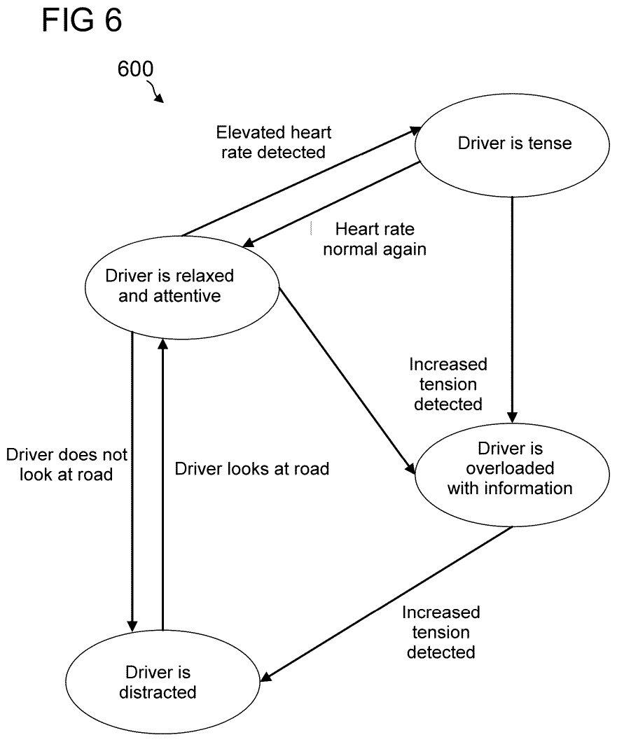

According to various aspects, the at least one processor of the information system can be configured to determine whether the attentiveness value is less than or equal to an attentiveness threshold value and if it is determined that the attentiveness value is less than or equal to the attentiveness threshold value, to categorize the driver as inattentive (see also FIG. 6).

For example, the driver monitoring system can include the imaging unit which acquires the image data of the driver. On the basis of these image data, for example, a frequency of a blinking of the driver can be determined, which represents the tension of the driver (driver is tense in the event of frequent blinking). A viewing direction of the driver can be determined, for example, on the basis of these image data. The viewing direction can represent the attentiveness of the driver. If they are not looking at the road, for example, this is an indication of inattentiveness of the driver, and vice versa. For example, it can be determined on the basis of the image data and the viewing direction whether they are looking at a portable user device (e.g., a smart phone, a tablet, etc.). If this is the case, the driver is inattentive. On the basis of the image data, for example, a chronological change of the viewing direction of the driver can be determined. If they look in different directions frequently, this can be an indication of tension (nervousness) of the driver. An age of the driver can be estimated from the image data, for example. If the driver is comparatively young (for example, less than 20 years) or comparatively old (for example, greater than 60 years), it can be determined that the driver tends toward higher tension.

According to various aspects, a processor of the driver monitoring system and/or the at least one processor of the information system can be configured to implement a machine learning model configured to output a prediction of a physical and/or mental state (also referred to as physical and/or mental condition) of the driver in reaction to an input of the sensor data (for example, including the image data) into the machine learning model.

A physical and/or mental state of the driver as used herein can include, for example, one or more than one physical and/or mental state of the following physical and/or mental states: attentiveness of the driver, tension of the driver, distraction of the driver, lack of concentration of the driver, a cognitive load of the driver, etc.

For illustration, various aspects are specified hereinafter with reference to attentiveness and/or tension of the driver as the exemplary physical and/or mental state. It is understood that these are exemplary for the physical and/or mental state of the driver and the specification applies accordingly to all other types which can represent the physical and/or mental state of the driver.

The at least one processor of the information system can be configured to determine such a driving task 510. If the vehicle 100 is an at least partially automated vehicle, the information system can receive the current driving task 510 in some aspects from the control device for controlling the vehicle 100. According to various aspects, one or more than one processor of the vehicle 100 can be configured to determine the current driving task 510 using data acquired by means of the data acquisition devices 112. Optionally, the at least one processor of the information system can be configured to determine the driver information 508 using the current driving task 510. For example, the current driving task 510 can indicate whether the vehicle 100 is currently driving forward or in reverse. It can be determined from speed signals and steering signals, for example, whether the current driving task 510 is a parking maneuver. It can be determined on the basis of the speed signals and on the basis of navigation signals (of the navigation system) whether the vehicle 100 is currently underway in an urban or rural area.

The at least one processor of the information system can be configured to determine or receive system information 512. The system information 512 can represent one or more than one message with respect to the vehicle 100 and/or an occupant of the vehicle 100 and/or an environment of the vehicle 100. As specified herein, a message of the one or more than one message can be a warning message, a status message, a notification message, an event message, etc.

The at least one processor of the information system can be configured to determine message presentation information 514 using the current driving task 510 and the driver information 508 and the system information 512. The message presentation information 514 can indicate for each of the one or more than one message whether the message is to be presented to the driver and/or how the message is to be presented to the driver and/or at what time the message is to be presented to the driver. Illustratively, the message presentation information 514 can indicate for a respective message whether the message is to be presented and, if the respective message is to be presented to the driver, how and at what time this message is to be presented to the driver.

The at least one processor of the information system can be configured to generate control instructions 516 for controlling the at least one component of the vehicle 100 (for example, the information system) to present the one or more than one message according to the message presentation information 514.

Various examples of the manner in which the messages can be presented to the driver are explained hereinafter. It is understood that these examples serve for illustration and any other manner is possible, by means of which a distraction of the driver as a result of the presentation of messages is reduced.

For example, the at least one processor of the information system can be configured to determine for each of the one or more than one message whether the message concerns the current driving task and to present a message either not at all or with a time delay if the message does not concern the current driving task.

For example, the at least one processor of the information system can be configured to determine probability information using the current driving task 508 and the driver information 508, which indicates for each of the one or more than one message with which probability a presentation of the message to the driver will cause less effective control of the vehicle (for example, distracts). In this case, for example, it can be determined that a message which will cause the driver to control the vehicle less effectively (for example, distracts them) with a probability which is greater than or equal to a probability threshold value is to be presented either not at all or at a later time.

According to various aspects, the at least one processor of the information system can be configured to present a message, which will cause the driver to control the vehicle less effectively (for example, distracts them) with a probability which is greater than or equal to a probability threshold value, and which does not relate to the current driving task 510 either with a time delay or not at all. According to various aspects, the at least one processor of the information system can be configured to present a message, which will cause the driver to control the vehicle less effectively (for example, distracts them) with a probability which is greater than or equal to a probability threshold value, and which does not relate to the current driving task 510 to the driver in an adapted manner (for example, with a time delay or in real time). This adapted manner can be such that the driver is not thus distracted. For example, a message in this case can be visually displayed on the dashboard 300, but an associated tone can be suppressed.

If the at least one processor of the information system determines that a message is associated with the current driving task 510, it can define that the message is to be presented to the driver without a time delay, for example, in the message presentation information 514 for this message.

According to various aspects, the viewing direction of the driver can be taken into account when determining the message presentation information 514. For example, the at least one processor of the information system can be configured to determine, using the viewing direction of the driver, whether they are looking toward the other display unit 402 of the presentation system (for example, to change a windshield wiper speed). If it is determined for a message that it concerns the current driving task 510 and is therefore to be presented to the driver 502 without a time delay, the message presentation information 514 can define in this case, for example, that the message is to be displayed on the other display unit 402. If the message is, for example, a warning message concerning the one situation in the environment of the vehicle 100 (for example, concerning an object in the environment of the vehicle 100), the message presentation information 514 can indicate that a notification sign (for example, an arrow) pointing in the direction of the situation is to be displayed on the other display unit 402. The notification sign can be any type of text, graphic, and/or audio feedback. The situation in the environment of the vehicle 100 can be, for example, an object (for example, an obstacle) in front of the vehicle 100 and/or an object (for example, an overtaking vehicle on the right lane during the driving task of the overtaking operation) behind or next to the vehicle. Additionally or alternatively to the notification sign, information at which the driver 502 is currently looking can be shifted to a different position on the display unit in order to guide the view of the driver 502 in the direction of the situation.

In some aspects, the information can be configured, if it determines that the driver 502 is inattentive and that there is a hazardous situation in the environment of the vehicle 502, to determine navigation data representing an adapted route of the vehicle so that the situation in the environment of the vehicle 100 is bypassed by means of the adapted route. The adapted navigation data can then be provided to the navigation system. Alternatively, the information system can provide the information and the navigation system can determine the adapted navigation data. If the driver, for example, does not recognize a pedestrian crossing, a different route guidance can be triggered by the navigation system as an output of the system. Additionally or alternatively, an additional message can be generated that is to be presented immediately to the driver 502 (for example, as a warning message with respect to the pedestrian crossing).

According to various aspects, the manner in which a message is to be presented can be determined using the age of the driver 502. For example, for older people different symbols (for example, in a larger size) can be used and/or additional information can be displayed (for example, caution pedestrian crossing), in order to improve the situational awareness of the driver 502.

According to various aspects, the one or more than one message can include multiple messages. In this case, the at least one processor of the information system can be configured to prioritize the multiple messages. If multiple messages relate to the current driving task 510, for example, each message of the multiple messages can be assigned a priority. It can then be determined using the priority at which time and in which manner (thus how) the respective message is to be presented to the driver 502. For example, a first message can have a higher priority than a second message and the first message can then be presented chronologically before the second message and/or, in the case of an auditory presentation, at higher volume than the second message.

According to various aspects, a number threshold value can be predefined. The number threshold value can indicate a maximum number of messages that are to be presented within a predefined period of time. The at least one processor of the information system can then be configured to determine the message presentation information 514 in such a way that the number of messages that are to be presented to the driver 502 in the predefined period of time is less than or equal to the number threshold value.

Illustratively, an information system is provided according to various aspects that takes into account both a driving situation and a state of the driver. According to various aspects, critical situations are identified and nonrelevant and potentially distracting messages are delayed until the situation becomes noncritical and the driver can process the information, or they are not presented to the driver at all.

Illustratively, it can be determined according to various aspects whether a message is helpful in a current driving situation and/or will probably cause the driver to control the vehicle less effectively (for example, distracts them). Numerous messages are not helpful in a current driving task 510, for example, such as status messages about a service in 1000 km, a status message about the particulate filter, etc. The status message that the tank is on reserve is thus not helpful during a parking operation, for example, but rather results in distraction of the driver.

It is understood that the state of the driver can change at any time. The state of the driver specified herein can therefore be a current state of the driver. FIG. 6 shows an exemplary state diagram of the state of the driver according to various aspects. In this exemplary state diagram, for example, the driver can be tense but nonetheless attentive and additional tension as a result of a presentation of one or more than one additional message can result in distraction of the driver.

According to various aspects, driver-specific information can be taken into consideration. For this purpose, the memory 104 can store respectively associated identification data for identifying the driver for one or more than one driver, for example. Furthermore, the memory 104 can store respective driver data for each of the one or more than one driver, which indicate a measure of a less effective vehicle control (for example, a measure of a distraction) of the driver due to messages.

In this case, the driver can be identified, for example, using the image data on the basis of the identification data stored in the memory and the message presentation information 514 can be determined using the driver data of the (identified) driver 502. If a driver is not recognized, a new profile can be created for the driver. The new profile can then comprise identification data determined using the image data and can include predefined driver data. According to various aspects, the driver data can be adapted for each driver online (thus while the driver is driving). For example, a reaction of the driver 502 to the presentation of one or more than one message can be acquired and it can be determined on the basis of the reaction whether the presentation of the one or more than one message has distracted the driver 502 (for example, to what extent). The driver data can then be adapted accordingly. Illustratively, a driver-specific behavior can be learned. The driver data can also indicate whether the driver 502 has already experienced the current driving task 510 at least once. The number of times the driver 502 has already experienced the current driving task 510 can be an indication of how high the level of concentration is that the driver requires for managing the driving task.

In some embodiments, the driver data can indicate a measure for each driving task, which indicates a distraction of the driver during the driving task as a result of messages.

In some embodiments, the driver data can indicate for each type of presentation of a plurality of types of presentation (e.g., auditory by means of a loudspeaker 404, visually on the dashboard 300, the other display unit 402 of the presentation system, etc.) a respective measure of less effective control of the vehicle (for example, a measure of a distraction) of the driver 502 due to messages. If a message is to be presented to the driver 502, it can be determined in this case using the driver data which type of presentation (for example, during the current driving task if the driver data are specific to the driving task) indicates the smallest degree of less effective control of the vehicle (for example, the smallest degree of distraction) of the driver 502.

The system can have learned, for example, that the driver 502 overreacts to specific tone frequencies and can select a more suitable tone. Overreactions, discomfort, anger, or nervousness of the driver can thus be reduced, so that the driver 502 can concentrate better on the current driving task 510.

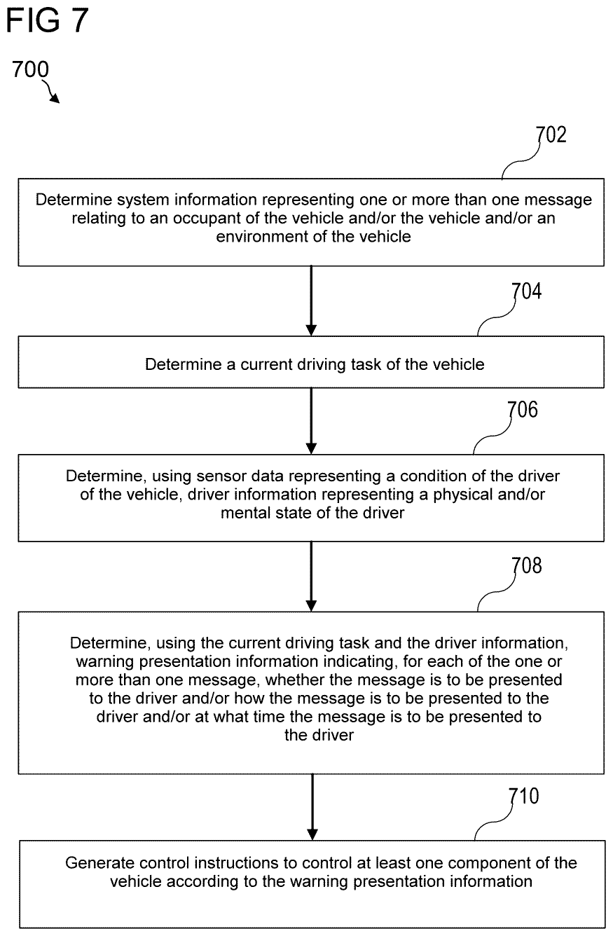

FIG. 7 shows a flow chart of a method 700 for controlling an information system of a vehicle according to various aspects.

The method 700 can include (in 702) determining system information representing one or more than one message relating to the vehicle and/or an occupant of the vehicle and/or an environment of the vehicle.

The method 700 can include (in 704) determining a current driving task of the vehicle.

The method 700 can include (in 706) determining, using sensor data representing a state of the driver of the vehicle, driver information representing attentiveness and/or tension of the driver.

The method 700 can include (in 708), determining, using the current driving task and the driver information, message presentation information indicating for each of the one or more than one message whether the message is to be presented to the driver and/or how the message is to be presented to the driver and/or at what time the message is to be presented to the driver.

The method 700 can include (in 710) generating control instructions to control at least one component of the vehicle according to the message presentation information.

Various examples specifying one or more aspects of the information system and the method 700 are provided hereinafter. It is understood that aspects which are specified with reference to the information system can also apply to the method and vice versa.

Example 1 is an information system for a vehicle, the information system including a processor configured to: determine system information representing one or more than one message (e.g., a warning message, a status message, a notification message, an event message, etc.) relating to an occupant of the vehicle and/or the vehicle and/or an environment of the vehicle; determine the current driving task of the driver; determine, using sensor data representing a state of the driver of the vehicle (for example, acoustic and/or visual information relating to the state of the driver), driver information representing a physical and/or mental state (for example, attentiveness (for example, represented by an attentiveness value) and/or tension (for example, represented by a tension value) of the driver; determine, using the current driving task and the driver information, message presentation information indicating, for each of the one or more than one message, whether the message is to be presented to the driver and/or how the message is to be presented to the driver and/or at what time the message is to be presented to the driver; and generate control instructions to control at least one component (e.g., a display unit, a loudspeaker, etc.) of the vehicle according to the message presentation information.

The physical and/or mental state of the driver can include, for example, attentiveness of the driver, attention of the driver, distraction of the driver, lack of concentration of the driver, and/or a cognitive load of the driver, etc.

Example 2 is configured according to example 1, wherein the processor is configured to: determine, using the current driving task and the driver information, probability information specifying for each of the one or more than one message with which probability a presentation of the message will cause the driver to control the vehicle less effectively (for example, distract them); and to determine the message presentation information using the probability information.

Example 3 is configured according to example 1 or 2, wherein the processor is configured to: determine for each of the one or more than one message whether the message concerns the current driving task; and if it is determined that a message does not concern the current driving task, determine whether a probability that the presentation of the message will cause the driver to control the vehicle less effectively (for example, distract them) is greater than or equal to a probability threshold value; and wherein, if the processor determines that the probability is greater than or equal to the probability threshold value, the message presentation information for the message indicates that the message is not to be presented or is to be presented with a time delay to the driver.

Example 4 is configured according to example 3, wherein, if the processor determines for a message that it concerns the current driving task, the message presentation information for the message indicates that the message is to be presented to the driver without a time delay.

In example 5, the information system according to any one of examples 1 to 4 further includes: an imaging unit (such as a camera) configured to acquire image data which include at least one image showing the driver, wherein the sensor data include the image data (which represent visual information with respect to the state of the driver).

Example 6 is configured according to example 5, wherein the image data include video data representing continuous images of the driver; wherein the processor is configured to determine, using the image data, a frequency of a blinking of the driver; and wherein the driver information determined using the frequency of the blinking of the driver represents the physical and/or mental state of the driver (for example, tension of the driver).

Example 7 is configured according to example 5 or 6, wherein the processor is configured to: using the image data, determine a viewing direction of the driver; wherein the driver information determined using the viewing direction represents the physical and/or mental state of the driver (for example, attentiveness of the driver).

Example 8 is configured according to example 7, wherein the processor is configured to: using the viewing direction of the driver, determine whether the driver is looking at a portable user device (such as a smart phone); if it is determined that the driver is looking at the portable user device, determine that the driver is distracted.

Example 9 is configured according to any one of examples 5 to 8, wherein the image data include video data representing continuous images of the driver; wherein the processor is configured: to determine using the video data, a chronological change of a viewing direction of the driver; and determine the driver information using the chronological change of the viewing direction of the driver.

Example 10 is configured according to any one of examples 5 to 9, wherein the processor is configured to: determine whether at least one message of the one or more than one message is a message relating to a situation in the environment of the vehicle (for example, in the direction of travel); and, using the viewing direction of the driver, determine whether the driver (for example, to change a windshield wiper speed) is looking at a display unit of a presentation system (for example, an infotainment system) (wherein the information system optionally includes the presentation system having the display unit); wherein, if it is determined that the driver is looking at the display unit and that at least one message of the one or more than one message is a message relating to the environment of the vehicle, the message presentation information for the at least one message indicates that the message is to be displayed (for example, without a time delay) on the display unit.

Example 11 is configured according to example 10, wherein, if it is determined that the driver is looking at the display unit and that at least one message of the one or more than one message is a message relating to the environment of the vehicle (for example, in the direction of travel), the message presentation information for the at least one message indicates that a notification character (for example, an arrow) pointing in the direction of the situation is to be displayed on the display unit.

In example 12, the information system according to any one of examples 1 to 11 further includes: a memory device storing, for one or more than one driver, respective associated identification data for identifying the driver and driver data, the driver data indicating a measure of a less effective vehicle control (for example, a measure of a distraction) of the driver due to messages; wherein the processor is configured to: determine the (current) driver of the vehicle using the image data and the identification data; and determine the message presentation information using the driver data associated with the driver.

Example 13 is configured according to example 12, wherein the processor is configured to: if the current driver of the vehicle cannot be determined using the image data and the identification data stored in the memory device, generate identification data of the current driver using the image data; and store the identification data of the current driver and predefined driver data for the current driver in the memory device.

Example 14 is configured according to example 12 or 13, wherein the driver data associated with a respective driver indicate, for each driving task of a plurality of driving tasks, a respective measure of a less effective vehicle control (for example, a measure of a distraction) of the driver due to messages; wherein the processor is configured to determine the message presentation information using the driver data associated with the driver and the current driving task.

Example 15 is configured according to example 14, wherein the driver data associated with a driver represent whether the driver has already experienced the current driving task at least once.

Example 16 is configured according to any one of examples 12 to 15, wherein the driver data associated with a respective driver indicate, for each presentation type of a plurality of presentation types (e.g., auditory by means of a loudspeaker, visually on a dashboard, a display unit of a presentation system (for example, an infotainment system), etc.) a respective measure of a less effective vehicle control (for example, a measure of a distraction) of the driver due to messages; (wherein the memory device optionally stores a respective predefined presentation type for each message); wherein the processor is configured to determine which presentation type of the plurality of presentation types (for example, for the current driving task if in connection with example 14) indicates the least amount of less effective vehicle control (for example, the least amount of distraction) of the driver of the vehicle, wherein the message presentation information indicates for at least one (for example, each) message of the one or more than one message that the message should be presented according to the (determined) presentation type indicating the least amount of less effective vehicle control (for example, the least amount of distraction) of the driver of the vehicle.

Example 17 is configured according to any one of examples 12 to 16, wherein the processor is configured to: receive reaction sensor data representing a reaction of the driver to the presentation of the one or more than one message according to the message presentation information; using the reaction sensor data, determine a vehicle control reduction value (for example, including a distraction value) indicating a measure of the less effective vehicle control (for example, a measure of the distraction) of the driver in reaction to the presentation of the one or more than one message; adapt the driver data stored in the memory device and associated with the driver using the (determined) vehicle control reduction value.

Example 18 is configured according to example 17, wherein the vehicle control reduction value indicates a measure of the less effective vehicle control (for example, a measure of the distraction) of the driver in reaction to the presentation of the one or more than one message in conjunction with the current driving task.

Example 19 is configured according to any one of examples 5 to 18, wherein the processor is configured to: using the viewing direction of the driver, determine whether the driver is looking at a first display unit of a presentation system (for example, an infotainment system) of the vehicle (wherein the information system optionally includes the presentation system having the first display unit) or whether the driver is looking at a second display unit of a dashboard of the vehicle (wherein the information system optionally includes the dashboard having the second display unit); wherein, if it is determined that the driver is looking at the first display unit, the message presentation information indicates for at least one message of the one or more than one message that the at least one message is to be displayed (for example, with or without a time delay) on the first display unit; and wherein, if it is determined that the driver is looking at the second display unit, the message presentation information for at least one message of the one or more than one message indicates that the at least one message is to be displayed (for example, with or without a time delay) on the second display unit.

Example 20 is configured according to any one of examples 1 to 19, wherein the physical and/or mental state includes an attentiveness of the driver, wherein the driver information includes an attentiveness value indicating a measure of the attentiveness of the driver; wherein the processor is configured to: determine whether at least one message of the one or more than one message is a message relating to a situation in the environment of the vehicle (for example, in the direction of travel); determine whether the attentiveness value is less than or equal to an attentiveness threshold value; and, if it is determined that the at least one message of the one or more than one message is a message relating to a situation in the environment of the vehicle and that the attentiveness value is less than or equal to an attentiveness threshold value: generate an additional message indicated by the message presentation information that should be presented to the driver without a time delay and notifies of the situation in the environment of the vehicle; and/or determine navigation data representing an adapted route of the vehicle, wherein the situation in the environment of the vehicle is bypassed by means of the adapted route, and generate navigation control instructions for controlling a navigation system of the vehicle according to the navigation data.

In example 21, the information system according to any one of examples 1 to 20 further includes: a microphone configured to acquire audio data representing noises generated by the driver (and therefore auditory information relating to the state of the driver).

In example 22, the information system according to any one of examples 1 to 21 further includes: a heart rate sensor configured to acquire heart rate data representing a heart rate of the driver (which represents a state of the driver); wherein the driver information determined using the heart rate data represents the physical and/or mental state of the driver (for example, a tension of the driver).

In example 23, the information system according to any one of examples 1 to 22 further includes: an environmental acquisition unit (for example, one or more than one data acquisition device 112) configured to acquire environmental data representing the environment of the vehicle.

Example 24 is configured according to example 23, wherein the processor is configured to: using the environmental data, determine one or more than one object in the environment of the vehicle; determine the driver information using the environmental data, wherein the driver information represents an attentiveness of the driver relating to the one or more than one object.

Example 25 is configured according to examples 5 and 24, wherein the processor is configured to, using the viewing direction of the driver, determine whether the driver is looking in the direction of the one or more than one object, and determine based thereon whether the driver observes the one or more than one object.

Example 26 is configured according to any one of examples 1 to 25, wherein the system information represents more than one message; wherein the processor is configured to, if it determines for the message presentation information that multiple messages of the more than one message are to be presented to the driver, determine a respective priority for each of the multiple messages; wherein the message presentation information indicates for the multiple messages that they are to be presented chronologically according to their respective priority.

Example 27 is configured according to any one of examples 1 to 26, wherein the processor is configured to, on the basis of a number of messages of the one or more than one message, determine which at least one message of the one or more than one message is to be presented to the driver.

Example 28 is configured according to any one of examples 1 to 27, wherein the processor is configured to determine the message presentation information in such a way that a number of messages to be presented to the driver in a predefined period of time is less than or equal to a number threshold value.

Example 29 is a method for controlling an information system of a vehicle, the method including: determining system information representing one or more than one message relating to an occupant of the vehicle and/or the vehicle and/or an environment of the vehicle; determining a current driving task of the vehicle; determining, using sensor data representing a state of the driver of the vehicle (for example, acoustic and/or visual information relating to the state of the driver), driver information representing an attentiveness (for example, represented by an attentiveness value) and/or tension (for example, represented by a tension value) of the driver; determining, using the current driving task and the driver information, message presentation information indicating, for each of the one or more than one message whether the message is to be presented to the driver and/or how the message is to be presented to the driver and/or at what time the message is to be presented to the driver; and generating control instructions to control at least one component (e.g., a display unit, a loudspeaker, etc.) of the information system according to the message presentation information.

Example 30 is configured according to example 29, wherein determining the message presentation information includes: determining, using the current driving task and the driver information, probability information indicating for each of the one or more than one message with which probability a presentation of the message to the driver will cause less effective vehicle control (for example, distract them); and determining the message presentation information using the probability information.

Example 31 is the method according to example 29 or 30, further including: for each of the one or more than one message, determining whether the message concerns the current driving task; and if it is determined that a message does not concern the current driving task, determining whether the probability that the presentation of the message will cause the driver to control the vehicle less effectively (for example, distract them) is greater than or equal to a probability threshold value; and wherein, if it is determined that the probability is greater than or equal to the probability threshold value, the message presentation information for the message indicates that the message is not to be presented or is to be presented with a time delay to the driver.

Example 32 is configured according to example 31, wherein, if it is determined for a message that it concerns the current driving task, the message presentation information for the message indicates that the message is to be presented to the driver without a time delay.

Example 33 is the method according to any one of examples 29 to 32, further including: acquiring image data (for example, by means of an imaging unit such as a camera), wherein the image data include at least one image showing the driver, wherein the sensor data include the image data (which represent visual information relating to the state of the driver).

Example 34 is configured according to example 33, wherein the image data include video data representing continuous images of the driver, wherein the method further includes: determining, using the image data, a frequency of a blinking of the driver; and wherein the driver information is determined using the frequency of the blinking of the driver and represents the physical and/or mental state of the driver (for example, a tension of the driver).

Example 35 is the method according to example 33 or 34, further including: determining a viewing direction of the driver using the image data; wherein the driver information is determined using the viewing direction and represents the physical and/or mental state of the driver (for example, an attentiveness of the driver).

Example 36 is the method according to example 35, further including: using the viewing direction of the driver, determining whether the driver is looking at a portable user device (such as a smart phone); if it is determined that the driver is looking at the portable user device, determining that the driver is distracted.

Example 37 is configured according to any one of examples 33 to 36, wherein the image data include video data representing continuous images of the driver; wherein the method further includes: using the video data, determining a chronological change of a viewing direction of the driver; and determining the driver information using the chronological change of the viewing direction of the driver.

Example 38 is configured according to any one of examples 33 to 37, wherein the method further includes: determining whether at least one message of the one or more than one message is a message relating to a situation in the environment of the vehicle (for example, in the direction of travel); and, using the viewing direction of the driver, determining whether the driver (for example, to change a windshield wiper speed) is looking at a display unit of a presentation system (for example, an infotainment system); wherein determining the message presentation information includes: if it is determined that the driver is looking at the display unit and that at least one message of the one or more than one message is a message relating to the environment of the vehicle, determining the message presentation information such that they indicate for the at least one message that the message is to be displayed (for example, without a time delay) on the display unit.

Example 39 is configured according to example 38, wherein determining the message presentation information includes: wherein, if it is determined that the driver is looking at the display unit and that at least one message of the one or more than one message is a message relating to the environment of the vehicle (for example, in the direction of travel), determining the message presentation information such that it indicates for the at least one message that a notification character (for example, an arrow) pointing in the direction of the situation is to be displayed on the display unit.

Example 40 is configured according to any one of examples 33 to 39, wherein a memory device stores identification data respectively associated with one or more than one driver for identification of the driver and driver data, wherein the driver data indicate a measure of a less effective vehicle control (for example, a measure of a distraction) of the driver due to messages, wherein the method further includes: using the image data and the identification data, determining the driver of the vehicle; wherein determining the message presentation information includes: determining the message presentation information using the driver data associated with the driver.

Example 41 is the method according to example 40, further including: if the current driver of the vehicle cannot be determined using the image data and identification data stored in the memory device, generating identification data of the current driver using the image data; and storing the identification data of the current driver and predefined driver data for the current driver in the memory device.

Example 42 is configured according to example 40 or 41, wherein the driver data associated with a respective driver indicate a respective measure of a less effective vehicle control (for example, a measure of a distraction) of the driver due to messages for each driving task of a plurality of driving tasks; wherein the method further includes: determining the message presentation information using the driver data associated with the driver and the current driving task.

Example 43 is configured according to example 42, wherein the driver data associated with a driver represent whether the driver has already experienced the current driving task at least once.

Example 44 is configured according to any one of examples 40 to 43, wherein the driver data associated with a respective driver indicate, for each presentation type of a plurality of presentation types (e.g., auditory by means of a loudspeaker, visually on a dashboard, a display unit of a presentation system (for example, an infotainment system), etc.) a respective measure of a less effective vehicle control (for example, a measure of a distraction) of the driver due to messages; wherein the method further includes: determining which presentation type of the plurality of presentation types (for example, for the current driving task) indicates the least measure of less effective vehicle control (for example, the least measure of distraction) of the driver of the vehicle; wherein the message presentation information is determined such that it indicates for at least one (for example, each) message of the one or more than one message that the message is to be presented according to the (determined) presentation type indicating the least measure of less effective vehicle control (for example, the least measure of distraction) of the driver of the vehicle.

Example 45 is configured according to any one of examples 40 to 44, wherein the method further includes: receiving reaction sensor data representing a reaction of the driver to the presentation of the one or more than one message according to the message presentation information; using the reaction sensor data, determining a vehicle control reduction value indicating a measure of the less effective vehicle control (for example, a measure of the distraction) of the driver in reaction to the presentation of the one or more than one message; adapting the driver data stored in the memory device and associated with the driver using the (determined) vehicle control reduction value.

Example 46 is configured according to example 45, wherein the vehicle control reduction value indicates a measure of the less effective vehicle control (for example, a measure of the distraction) of the driver in reaction to the presentation of the one or more than one message in conjunction with the current driving task.

Example 47 is configured according to any one of examples 33 to 46, wherein the method further includes: using the viewing direction of the driver, determining whether the driver is looking at a first display unit of a presentation system (for example, an infotainment system) of the vehicle or whether the driver is looking at a second display unit of a dashboard of the vehicle; wherein, if it is determined that the driver is looking at the first display unit, the message presentation information being determined in such a way that it indicates for at least one message of the one or more than one message that the at least one message is to be displayed (for example, with or without a time delay) on the first display unit; and wherein, if it is determined that the driver is looking at the second display unit, the message presentation information being determined in such a way that for at least one message of the one or more than one message it indicates that the at least one message is to be displayed (for example, with or without a time delay) on the second display unit.

Example 48 is configured according to any one of examples 29 to 47, wherein the physical and/or mental state includes an attentiveness of the driver, wherein the driver information includes an attentiveness value indicating a measure of the attentiveness of the driver; wherein the method further includes: determining whether at least one message of the one or more than one message is a message relating to a situation in the environment of the vehicle (for example, in the direction of travel); determining whether the attentiveness value is less than or equal to an attentiveness threshold value; and if it is determined that at least one message of the one or more than one message is a message relating to a situation in the environment of the vehicle and that the attentiveness value is less than or equal to an attentiveness threshold value: generating an additional message indicated by the message presentation information, which is to be presented to the driver without a time delay and notifies of the situation in the environment of the vehicle; and/or determining navigation data representing an adapted route of the vehicle, wherein the situation in the environment of the vehicle is bypassed by means of the adapted route, and generating navigation control instructions for controlling a navigation system of the vehicle according to the navigation data.

Example 49 is the method according to any one of examples 29 to 48, further including: acquiring audio data (for example, by means of a microphone) representing noises generated by the driver (and therefore auditory information relating to the state of the driver).

Example 50 is the method according to any one of examples 29 to 49, further including: acquiring heart rate data (for example, by means of a heart rate sensor) representing a heart rate of the driver (which represents a state of the driver); wherein the driver information is determined using the heart rate data and represents the physical and/or mental state of the driver (for example, a tension of the driver).

Example 51 is the method according to any one of examples 29 to 50, further including: acquiring environmental data (for example, by means of an environment acquisition unit) representing the environment of the vehicle; using the environmental data, determining one or more than one object in the environment of the vehicle; determining the driver information using the environmental data, wherein the driver information represents an attentiveness of the driver with respect to the one or more than one object.

Example 52 is the method according to examples 33 and 51, further including: using the viewing direction of the driver, determining whether the driver is looking in the direction of the one or more than one object, and, based thereon, determining whether the driver observes the one or more than one object.

Example 53 is configured according to any one of examples 29 to 52, wherein the system information represents more than one message; wherein the method further includes: if it is determined in the determination of the message presentation information that multiple messages of the more than one message are to be presented to the driver, determining a respective priority for each of the multiple messages; determining the message presentation information such that it indicates for the multiple messages that the multiple messages are to be presented chronologically according to their respective priority.

Example 54 is the method according to any one of examples 29 to 53, further including: determining on the basis of a number of messages of the one or more than one message which at least one message of the one or more than one message is to be presented to the driver.

Example 55 is configured according to any one of examples 29 to 54, wherein the message presentation information is determined such that a number of messages to be presented to the driver in a predefined period of time is less than or equal to a number threshold value.

Example 56 is a (for example, non-transitory) computer-readable medium (e.g., a computer program product, a nonvolatile memory medium, a non-transitory memory medium, or a nonvolatile memory medium), which stores instructions which, upon execution by a processor, cause the processor to control a device in order to perform a method according to any one of examples 29 to 55.

Example 57 is one or more than one means for performing the method according to any one of examples 29 to 55.

Example 58 is a vehicle including the information system according to any one of examples 1 to 28.

In the above specification and the associated figures, the components of electronic devices are sometimes shown as separate elements. In this regard, it is understood that discrete elements can be combined or integrated to form a single element. This includes the combination of two or more circuits to form a single circuit, the installation of two or more circuits on a common chip or chassis to form an integrated element, the execution of discrete software components on a common processor core, etc. Vice versa, it is understood that a single element can be divided into two or more discrete elements, such as the division of a single circuit into two or more separate circuits, the division of a chip or chassis into discrete elements, which were originally provided thereon, the division of a software component into two or more sections and the execution thereof on a separate processor core, etc.

It is presumed that the implementations of the methods specified herein have demonstrative character and can therefore be implemented in a corresponding device. It is also presumed that implementations of the device described herein can be implemented as a corresponding method. It is therefore apparent that a device corresponding to a method specified herein can include one or more components configured so as to execute each aspect of the corresponding method.

While the invention has been shown and specified in particular with reference to specific embodiments, it is understood that various changes of the design can be made without deviating from the scope of the invention as defined by the appended claims. The scope of the invention is therefore defined by the appended claims and all changes which fall in the meaning and the area of an equivalence of the claims are therefore included.

1. An information system for a vehicle, the information system comprising a processor configured to:
determine system information representing one or more than one message relating to an occupant of the vehicle and/or the vehicle and/or an environment of the vehicle
determine a current driving task of the vehicle;
determine, using sensor data representing a condition of a driver of the vehicle, driver information representing a physical and/or mental state of the driver;
determine, using the current driving task and the driver information, message presentation information indicating, for each of the one or more than one message, whether the message is to be presented to the driver and/or how the message is to be presented to the driver and/or at what time the message is to be presented to the driver; and
generate control instructions to control at least one component of the vehicle according to the message presentation information.

2. The information system of claim 1,
wherein the processor is configured to:
determine for each of the one or more than one message whether the message concerns the current driving task; and
if it is determined that a message does not concern the current driving task, determine whether a probability that the presentation of the message will cause the driver to control the vehicle less effectively is greater than or equal to a probability threshold value; and
wherein, if the processor determines that the probability is greater than or equal to the probability threshold value, the message presentation information indicate that the message is to not be presented or is to be presented with a time delay.

3. The information system of claim 1, further comprising:
an imaging unit configured to acquire image data which comprise at least one image showing the driver, wherein the sensor data comprise the image data.

4. The information system of claim 3,
wherein the image data comprise video data representing continuous images of the driver, wherein the processor is configured to determine, using the image data, a frequency of a blinking of the driver; and wherein the driver information determined using the frequency of the blinking of the driver represents the physical and/or mental state.

5. The information system of claim 3,
wherein the processor is configured to: using the image data, determine a viewing direction of the driver, wherein the driver information determined using the viewing direction represents the physical and/or mental state of the driver.

6. The information system of claim 3, further comprising:
a memory device storing, for one or more than one driver, respective associated identification data for identifying the driver and driver data, the driver data indicating a measure of a less effective vehicle control of the driver due to messages;
wherein the processor is configured to:
determine the driver of the vehicle using the image data and the identification data; and
determine the message presentation information using the driver data associated with the driver.

7. The information system of claim 6,
wherein the driver data associated with a respective driver indicate, for each driving task of a plurality of driving tasks, a respective measure of a less effective vehicle control of the driver due to messages; and
wherein the processor is configured to determine the message presentation information using the driver data associated with the driver and the current driving task.

8. The information system of claim 6,
wherein the driver data associated with a respective driver indicate, for each presentation type of a plurality of presentation types, a respective measure of a less effective vehicle control of the driver due to messages; and
wherein the processor is configured to determine which presentation type of the plurality of presentation types indicates the least amount of less effective vehicle control of the driver of the vehicle, wherein the message presentation information indicates for at least one message of the one or more than one message that the message should be presented according to the presentation type indicating the least amount of less effective vehicle control of the driver of the vehicle.

9. A vehicle comprising the information system of claim 1.

10. A method for controlling an information system of a vehicle, the method comprising:
determining system information representing one or more than one message relating to an occupant of the vehicle and/or the vehicle and/or an environment of the vehicle
determining a current driving task of the vehicle;
determining, using sensor data representing a condition of a driver of the vehicle, driver information representing a physical and/or mental state of the driver;
determining, using the current driving task and the driver information, message presentation information indicating, for each of the one or more than one message, whether the message is to be presented to the driver and/or how the message is to be presented to the driver and/or at what time the message is to be presented to the driver; and
generating control instructions to control at least one component of the information system according to the message presentation information.

11. The method of claim 10, further comprising:
determining for each of the one or more than one message whether the message concerns the current driving task; and
if it is determined that a message does not concern the current driving task, determining whether a probability that the presentation of the message will cause the driver to control the vehicle less effectively is greater than or equal to a probability threshold value; and
wherein, if it is determined that the probability is greater than or equal to the probability threshold value, the message presentation information indicate that the message is to not be presented or is to be presented with a time delay.

12. The method of claim 10, further comprising:
an imaging unit configured to acquire image data which comprise at least one image showing the driver, wherein the sensor data comprise the image data.

13. The method of claim 12,
wherein the image data comprise video data representing continuous images of the driver; and
further comprising determining, using the image data, a frequency of a blinking of the driver; and wherein the driver information determined using the frequency of the blinking of the driver represents the physical and/or mental state.

14. The method of claim 12,
further comprising:
determining, from the image data, a viewing direction of the driver, wherein the driver information determined using the viewing direction represents the physical and/or mental state of the driver.

15. The method of claim 12, further comprising:
a memory device storing, for one or more than one driver, respective associated identification data for identifying the driver and driver data, the driver data indicating a measure of a less effective vehicle control of the driver due to messages;
further comprising:
determining the driver of the vehicle using the image data and the identification data; and
determining the message presentation information using the driver data associated with the driver.

16. The method of claim 15,
wherein the driver data associated with a respective driver indicate, for each driving task of a plurality of driving tasks, a respective measure of a less effective vehicle control of the driver due to messages; and
further comprising determining the message presentation information using the driver data associated with the driver and the current driving task.

17. A non-transitory computer-readable medium storing instructions, which, when executed by a processor, cause the processor to control a device to:
determine system information representing one or more than one message relating to an occupant of a vehicle and/or the vehicle and/or an environment of the vehicle
determining a current driving task of the vehicle;
determine, using sensor data representing a condition of a driver of the vehicle, driver information representing a physical and/or mental state of the driver;
determine, using the current driving task and the driver information, message presentation information indicating, for each of the one or more than one message, whether the message is to be presented to the driver and/or how the message is to be presented to the driver and/or at what time the message is to be presented to the driver; and
generate control instructions to control at least one component of the information system according to the message presentation information.

18. The non-transitory computer-readable medium of claim 17, wherein the instructions are further configured to cause the processor to:
determine for each of the one or more than one message whether the message concerns the current driving task; and
if it is determined that a message does not concern the current driving task, determine whether a probability that the presentation of the message will cause the driver to control the vehicle less effectively is greater than or equal to a probability threshold value; and
wherein, if it is determined that the probability is greater than or equal to the probability threshold value, the message presentation information indicate that the message is to not be presented or is to be presented with a time delay.

19. The non-transitory computer-readable medium of claim 17, wherein the instructions are further configured to cause the processor to:
determine, using image data, a frequency of a blinking of the driver; and
wherein the driver information determined using the frequency of the blinking of the driver represents the physical and/or mental state.

20. The non-transitory computer-readable medium of claim 19, wherein the instructions are further configured to cause the processor to determine from the image data a viewing direction of the driver, wherein the driver information determined using the viewing direction represents the physical and/or mental state of the driver.
